(19) United States
(12) Patent Application Publication
(10) Pub. No.: US 2016/0194557 A1
(43) Pub. Date: Jul. 7, 2016

(54) Stabilizer or Binder and Manufacturing Method Thereof for Phosphorescent Materials

(71) Applicant: Wah Hong Industrial Corp., Kaohsiung (TW)

(72) Inventors: Hsin-Yi Wen, Kaohsiung (TW); Chih-Chen Wu, Kaohsiung (TW)

(21) Appl. No.: 14/946,840

(22) Filed: Nov. 20, 2015

(30) Foreign Application Priority Data
Jan. 6, 2015 (TW) 104100324

(51) Int. Cl. C09K 11/02

(52) U.S. Cl. CPC C09K 11/02

(57) ABSTRACT

A manufacturing method of phosphor stabilizer includes: modifying trimethoxysilylpropyl with polyethylenimine in methylbenzene to obtain a first solution; heating the first solution at a predetermined temperature; dissolving epoxide in methylbenzene to obtain a second solution; and reacting the first solution with the second solution by stirring to obtain a reactant. The reactant is a stabilizer or a binder to combine with a phosphor or a quantum dot material to form a synthetic which is further cooled and purified to obtain a colloid material. The synthetic has a functional group to combine with the phosphor or the quantum dot material for enhancing dispersion, thermal stability and light absorbability for light emitting.

### BACKGROUND OF THE INVENTION

1. Field of the Invention

The present invention relates to a stabilizer or binder and manufacturing method thereof for phosphors. Particularly, the present invention relates to the binder and manufacturing method thereof for QD (quantum dot) materials. More particularly, the present invention relates to the stabilizer or absorbent formed from a dispersion carrier of the phosphors.

2. Description of the Related Art

US Patent Application Publication No. 2012/0138894, entitled “STABLE AND ALL SOLUTION PROCESSABLE QUANTUM DOT LIGHT-EMITTING DIODES,” discloses quantum dot light emitting diodes (QD-LEDs) where the electron injection and transport layer comprises inorganic nanoparticles (I-NPs). The use of I-NPs results in an improved QD-LED over those having a conventional organic based electron injection and transport layer and does not require chemical reaction to form the inorganic layer. In one embodiment of the invention, the hole injection and transport layer can be metal oxide nanoparticles (MO-NPs) which allows the entire device to have the stability of an all inorganic system and permit formation of the QD-LED by a series of relatively inexpensive steps involving deposition of suspensions of nanoparticles and removing the suspending vehicle.

Further, US Patent Application Publication No. 2015/0021521, entitled “QUANTUM DOT-CONTAINING COMPOSITIONS INCLUDING AN EMISSION STABILIZER, PRODUCTS INCLUDING SAME, AND METHOD,” discloses a composition including quantum dots and an emission stabilizer, products including same, and methods, including methods for improving, or enhancing the emission stability of quantum dots. Inclusion of an emission stabilizer in a composition can improve or enhance the stability of at least one emissive property of the quantum dots in the composition against degradation compared to a composition that is the same in all respects except that it does not include the emission stabilizer. Examples of such emissive properties include lumen output, lumen stability, color point (e.g., CIE x, CIE y) stability, wavelength stability, FWHM of the major peak emission, absorption, solid state EQE, and quantum dot emission efficiency.

Further, US Patent Application Publication No. 2015/0204515, entitled “HIGHLY STABLE QDS-COMPOSITES FOR SOLID STATE LIGHTING AND THE METHOD OF MAKING THEM THROUGH INITIATOR-FREE POLYMERIZATION,” discloses a lighting device comprising a light source configured to generate light source light, and (ii) a light converter configured to convert at least part of the light source light into visible converter light. The light converter comprises a polymeric host material with light converter nanoparticles embedded in the polymeric host material. The polymeric host material is based on radical polymerizable monomers, and the polymeric host material contains equal to or less then 5 ppm radical initiator based material relative to the total weight of the polymeric host material.

Further, US Patent Application Publication No. 2013/0345458, entitled “SILICONE LIGANDS FOR STABILIZING QUANTUM DOT FILMS,” discloses siloxane polymer ligands for binding to quantum dots. The polymers include a multiplicity of amine or carboxy binding ligands in combination with long-alkyl chains providing improved stability for the ligated quantum dots. The ligands and coated nanostructures of the present invention are useful for close packed nanostructure compositions, which can have improved quantum confinement and/or reduced cross-talk between nano structures.

However, there is a need of improving the phosphor for enhancing luminant stability and thermal stability. The above-mentioned patent application publications are incorporated herein by reference for purposes including, but not limited to, indicating the background of the present invention and illustrating the situation of the art.

As is described in greater detail below, the present invention provides a phosphor stabilizer and manufacturing method thereof. In combination reaction, a trimethoxysilylpropyl-modified polyethylenimine material reacts with an epoxy material to form a reactant which further reacts with a phosphor to form a colloid phosphor in such a way as to enhance the luminous stability and the thermal stability of the conventional phosphor.

### SUMMARY OF THE INVENTION

The primary objective of this invention is to provide a phosphor stabilizer and manufacturing method thereof. In combination reaction, a trimethoxysilylpropyl-modified polyethylenimine material reacts with an epoxy material to form a reactant which further reacts with a phosphor to form a colloid phosphor. Advantageously, the phosphor stabilizer of the present invention is successful in enhancing a high degree of luminous stability and thermal stability.

The phosphor stabilizer in accordance with an aspect of the present invention includes:

a trimethoxysilylpropyl-modified polyethylenimine material provided with a first predetermined amount;

an epoxy material provided with a second predetermined amount; and

a reactant formed from the trimethoxysilylpropyl-modified polyethylenimine material reacted with the epoxy material in combination reaction;

wherein the reactant is a dispersion carrier performed as a stabilizer or a binder for reacting with a phosphor or a QD material to form a colloid phosphor material for enhancing a degree of luminous stability and thermal stability.

The phosphorescent material in accordance with an aspect of the present invention includes:

a phosphor or a QD material provided with a first predetermined amount;

a dispersion carrier provided with a second predetermined amount; and

a colloid phosphor material formed from the a first predetermined amount of the phosphor or the QD material reacted with the second predetermined amount of the dispersion carrier in a first combination reaction;

wherein in a second combination reaction the dispersion carrier is formed from a trimethoxysilylpropyl-modified polyethylenimine material reacted with an epoxy material in combination reaction.

In a separate aspect of the present invention, the trimethoxysilylpropyl-modified polyethylenimine material having a functional group for modifying and bonding polyethylenimine is a free radical of a trimethoxysilylpropyl material.

In a further separate aspect of the present invention, the trimethoxysilylpropyl material is C₆H₁₅O₃Si or C₆H₁₇O₃NSi.

In yet a further separate aspect of the present invention, the epoxy material is C₁₃H₁₆O₄, C₉H₁₀O₂, C₁₀H₁₂O₂, C₁₂H₁₆O₂, C₁₁H₁₄O₂, C₉H₁₀O, C₁₂H₁₆O₃, C₁₂H₁₄O₄, C₁₀H₁₂O₃, C₁₈H₂₈O₂, C₁₁H₁₄O₃, C₉H₁₀O, C₁₁H₁₂O₃, C₉H₉O₂F, C₁₀H₁₂O₂, C₁₅H₁₄O₂, C₉H₁₀O₂, C₁₄H₁₆O₃N₂, C₁₂H₁₄O₃, C₉H₉O₃N, C₁₈H₁₈O₃, C₁₅H₁₃O₂N, C₁₃H₁₂O₂, C₁₉H₃₈O₂, C₁₁H₂₂O₂, C₁₃H₂₆O₂, C₁₅H₃₀O₂, C₁₇H₃₄O₂, C₁₂H₈O₂F₁₆, C₈H₈O₂F₈, C₅H₆O₂F₄, C₁₁H₅OF₁₇, C₉H₅OF₁₃, C₁₁H₁₄O₄, C₁₁H₁₃O₃N, C₁₂H₁₄O₃, C₁₃H₁₈O₂, C₁₄H₂₀O₂, C₁₂H₁₄O₃, C₁₀H₉O₂F₃, C₁₀H₁₀O₄, C₁₂H₁₄O₂, C₁₄H₁₈O₂, C₁₃H₁₆O₄ or C₁₂H₁₆O₂.

In yet a further separate aspect of the present invention, the phosphor includes semiconductor nano-crystalline particles, metallic oxide particles and core-shell nano-crystals.

In yet a further separate aspect of the present invention, the phosphor includes compounds of AgINS₂ and CuINS₂ in groups I-VI; compounds of CdSe, CdTe, ZnS, ZnSe, ZnTe, ZnO, HgS, HgSe, HgTe, CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, CdZnSeS, CdZnSeTe, CdZnSTe, CdHgSeS, CdHgSeTe, CdHgSTe, HgZnSeS, HgZnSeTe and HgZnSTe in groups II-VI; compounds of GaN, GaP, GaAs, GaSb, AlN, AlP, AlAs, AlSb, InN, InP, InAs, InSb, GaNP, GaNAs, GaNSb, GaPAs, GaPSb, AlNP, AlNAs, AlNSb, AlPAs, AlPSb, InNP, InNAs, InNSb, InPAs, InPSb, GaAlNP, GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs and InAlPSb in groups III-V; compounds of SnS, SnSe, SnTe, PbS, PbSe, PbTe, SnSeS, SnSeTe, SnSTe, PbSeS, PbSeTe, PbSTe, SnPbS, SnPbSe, SnPbTe, SnPbSSe, SnPbSeTe and SnPbSTe in groups IV-VI; compounds of Si, Ge, SiC and SiGe in group IV.

The manufacturing method of phosphorescent materials in accordance with an aspect of the present invention includes:

modifying a trimethoxysilylpropyl material with a polyethylenimine material in methylbenzene to obtain a trimethoxysilylpropyl-modified polyethylenimine material in a first solution;

heating the trimethoxysilylpropyl-modified polyethylenimine material of the first solution in a predetermined temperature;

dissolving an epoxy material in methylbenzene to obtain a second solution; and

reacting the heated first solution with the second solution in a reactor by stirring to obtain a reactant;

wherein the reactant is a dispersion carrier for reacting with a phosphor or a quantum dot material to form a phosphorescent synthetic.

In a separate aspect of the present invention, the predetermined temperature ranges between 80 and 120 degrees centigrade.

In a further separate aspect of the present invention, the heated first solution and the second solution are supplied with a predetermined molar ratio ranging between 1:2 to 1:4.

In yet a further separate aspect of the present invention, the phosphorescent synthetic is further cooled and purified to obtain a colloid phosphor material.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIGS. 1-1 and 1-2 are a set of chemical structure views of trimethoxysilylpropyl materials applied in a phosphor stabilizer in accordance with a preferred embodiment of the present invention.

FIGS. 2-1 to 2-50 are a set of chemical structure views of various epoxy materials applied in the phosphor stabilizer in accordance with the preferred embodiment of the present invention.

FIG. 3 is a flow chart of a manufacturing method of the phosphor stabilizer in accordance with a first preferred embodiment of the present invention.

FIG. 3A is a flow chart of a manufacturing method of the phosphor stabilizer in accordance with a second preferred embodiment of the present invention.

FIG. 4 is a chart illustrating wavelengths in relation to luminous intensities of a phosphor in accordance with a preferred embodiment of the present invention.

### DETAILED DESCRIPTION OF THE INVENTION

It is noted that a phosphor stabilizer and manufacturing method thereof in accordance with the preferred embodiment of the present invention can be applicable to various phosphor materials (or fluorescent materials) and devices thereof. The phosphor stabilizer in accordance with the preferred embodiment of the present invention can be used as a stabilizer, an absorbent or a dispersion carrier for phosphors or are applicable to phosphorescent materials, displays, optoelectronics, biomedical engineering or other technical field, which are not limitative of the present invention.

By way of example, the phosphor stabilizer includes at least one trimethoxysilylpropyl-modified polyethylenimine material and at least one epoxy material. The trimethoxysilylpropyl-modified polyethylenimine material is provided with a first predetermined amount while the epoxy material is provided with a second predetermined amount. In combination reaction, the first predetermined amount of the trimethoxysilylpropyl-modified polyethylenimine material reacts with the second predetermined amount of the epoxy material to form a reactant. The reactant is used as a dispersion carrier which can further react with a phosphor or a QD material for enhancing a degree of luminous stability and thermal stability thereof.

Furthermore, the phosphor stabilizer of the present invention can be used as a stabilizer or an absorbent to stabilize the phosphor or the QD material, or as a surface stabilizer to coat or to displace a surface of the phosphor or the QD material. By way of example, the phosphor includes compounds of AgINS₂ and CuINS₂ in groups I-VI; compounds of CdSe, CdTe, ZnS, ZnSe, ZnTe, ZnO, HgS, HgSe, HgTe, CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, CdZnSeS, CdZnSeTe, CdZnSTe, CdHgSeS, CdHgSeTe, CdHgSTe, HgZnSeS, HgZnSeTe and HgZnSTe in groups II-VI; compounds of GaN, GaP, GaAs, GaSb, AlN, AlP, AlAs, AlSb, InN, InP, InAs, InSb, GaNP, GaNAs, GaNSb, GaPAs, GaPSb, AlNP, AlNAs, AlNSb, AlPAs, AlPSb, InNP, InNAs, InNSb, InPAs, InPSb, GaAlNP, GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs and InAlPSb in groups III-V; compounds of SnS, SnSe, SnTe, PbS, PbSe, PbTe, SnSeS, SnSeTe, SnSTe, PbSeS, PbSeTe, PbSTe, SnPbS, SnPbSe, SnPbTe, SnPbSSe, SnPbSeTe and SnPbSTe in groups IV-VI; compounds of Si, Ge, SiC and SiGe in group IV.

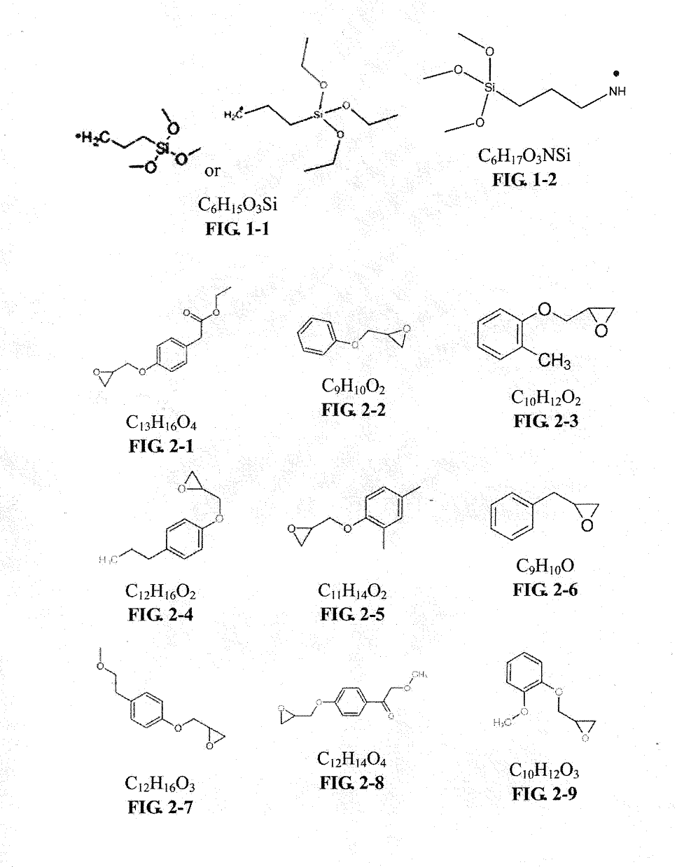

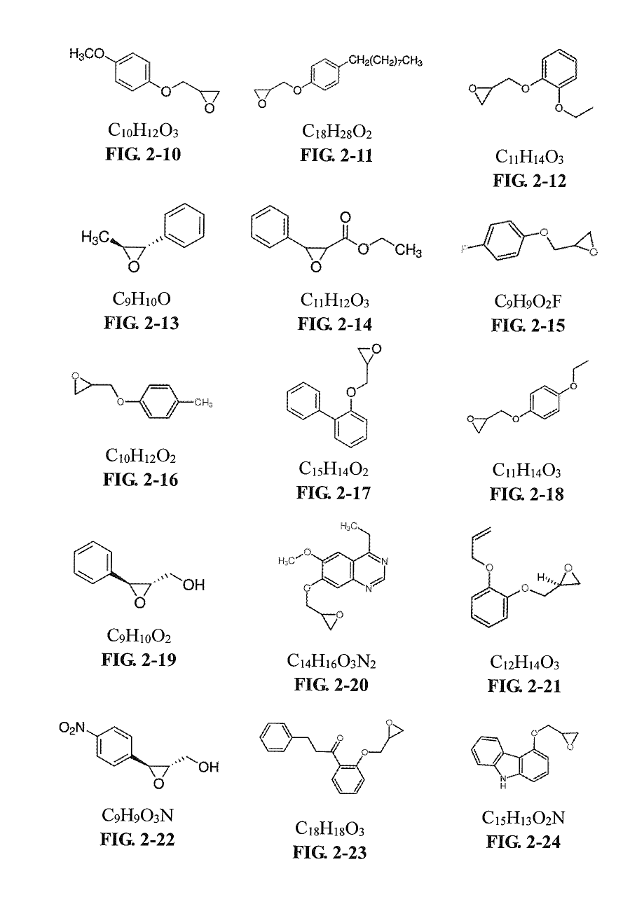

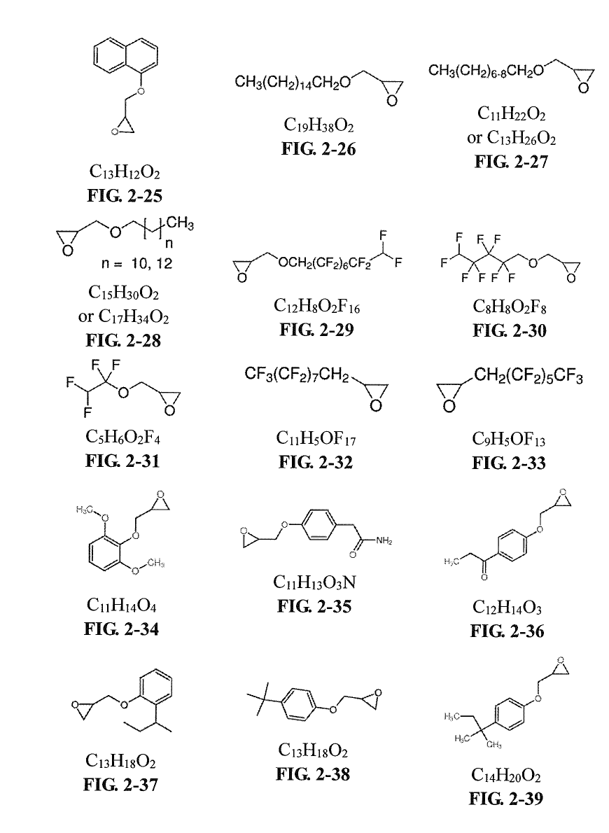

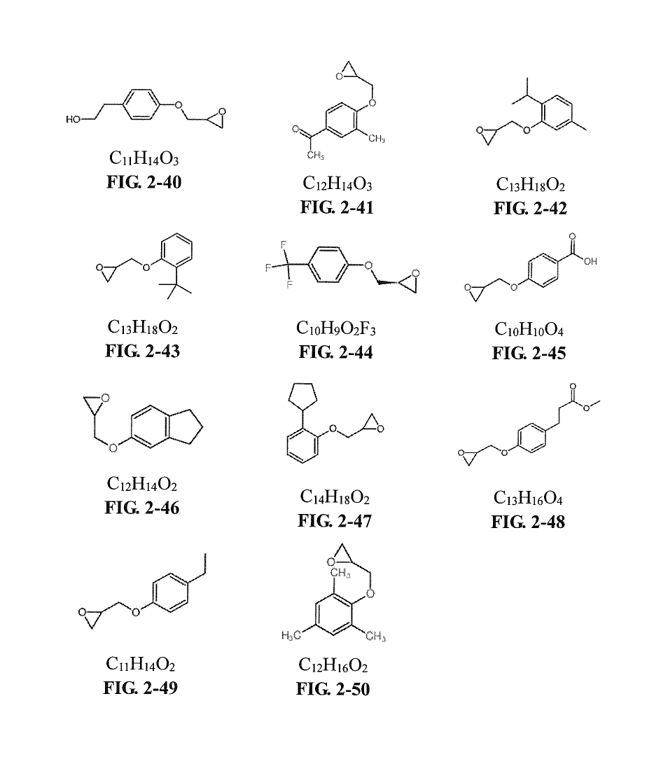

FIGS. 1-1 and 1-2 show a set of chemical structure views of the trimethoxysilylpropyl materials suitably applied in the phosphor stabilizer in accordance with a preferred embodiment of the present invention. Referring now to FIGS. 1-1 and 1-2, the phosphor stabilizer in accordance with the preferred embodiment of the present invention can utilize the trimethoxysilylpropyl-modified polyethylenimine material having a functional group for modifying and bonding polyethylenimine is a free radical of the trimethoxysilylpropyl material. For example, the trimethoxysilylpropyl material can be selected from C₆H₁₅O₃Si (as shown in FIG. 1-1) or C₆H₁₇O₃NSi (as shown in FIG. 1-2).

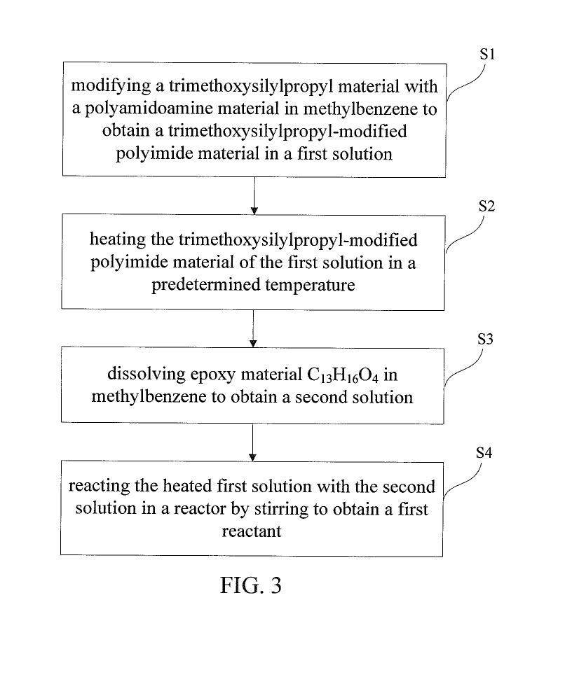

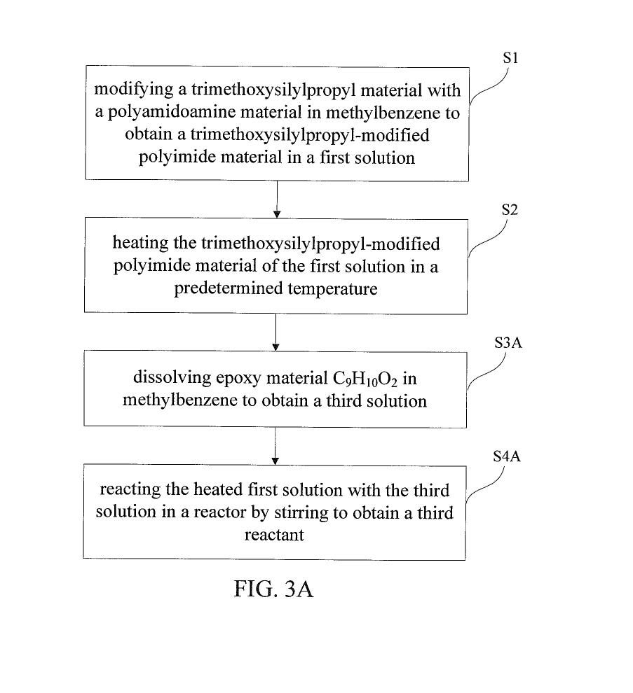

FIGS. 2-1 to 2-50 show a set of chemical structure views of various epoxy materials suitably applied in the phosphor stabilizer in accordance with the preferred embodiment of the present invention. Referring to FIGS. 2-1 to 2-50, the phosphor stabilizer in accordance with the preferred embodiment of the present invention can utilize the epoxy materials for reacting with the trimethoxysilylpropyl-modified polyethylenimine material. By way of example, the epoxy material can be selected from C₁₃H₁₆O₄ (as shown in FIG. 2-1), C₉H₁₀O₂ (as shown in FIG. 2-2), C₁₀H₁₂O₂ (as shown in FIG. 2-3), C₁₂H₁₆O₂ (as shown in FIG. 2-4), C₁₁H₁₄O₂ (as shown in FIG. 2-5), C₉H₁₀O (as shown in FIG. 2-6), C₁₂H₁₆O₃ (as shown in FIG. 2-7), C₁₂H₁₄O₄ (as shown in FIG. 2-8), C₁₀H₁₂O₃ (as shown in FIGS. 2-9 and 2-10), C₁₈H₂₈O₂ (as shown in FIG. 2-11), C₁₁H₁₄O₃ (as shown in FIG. 2-12), C₉H₁₀O (as shown in FIG. 2-13), C₁₁H₁₂O₃ (as shown in FIG. 2-14), C₉H₉O₂F (as shown in FIG. 2-15), C₁₀H₁₂O₂ (as shown in FIG. 2-16), C₁₅H₁₄O₂ (as shown in FIG. 2-17), C₁₁H₁₄O₃ (as shown in FIG. 2-18), C₉H₁₀O₂ (as shown in FIG. 2-19), C₁₄H₁₆O₃N₂ (as shown in FIG. 2-20), C₁₂H₁₄O₃ (as shown in FIG. 2-21), C₉H₉O₃N (as shown in FIG. 2-22), C₁₈H₁₈O₃ (as shown in FIG. 2-23), C₁₅H₁₃O₂N (as shown in FIG. 2-24), C₁₃H₁₂O₂ (as shown in FIG. 2-25), C₁₉H₃₈O₂ (as shown in FIG. 2-26), C₁₁H₂₂O₂ (as shown in FIG. 2-27), C₁₃H₂₆O₂ (as shown in FIG. 2-27), C₁₅H₃₀O₂ (as shown in FIG. 2-28), C₁₇H₃₄O₂ (as shown in FIG. 2-28), C₁₂H₈O₂F₁₆ (as shown in FIG. 2-29), C₈H₈O₂F₈ (as shown in FIG. 2-30), C₅H₆O₂F₄ (as shown in FIG. 2-31), C₁₁H₅OF₁₇ (as shown in FIG. 2-32), C₉H₅OF₁₃ (as shown in FIG. 2-33), C₁₁H₁₄O₄ (as shown in FIG. 2-34), C₁₁H₁₃O₃N (as shown in FIG. 2-35), C₁₂H₁₄O₃ (as shown in FIG. 2-36), C₁₃H₁₈O₂ (as shown in FIGS. 2-37 and 2-38), C₁₄H₂₀O₂ (as shown in FIG. 2-39), C₁₁H₁₄O₃ (as shown in FIG. 2-40), C₁₂H₁₄O₃ (as shown in FIG. 2-41), C₁₃H₁₈O₂ (as shown in FIGS. 2-42 and 2-43), C₁₀H₉O₂F₃ (as shown in FIG. 2-44), C₁₀H₁₀O₄ (as shown in FIG. 2-45), C₁₂H₁₄O₂ (as shown in FIG. 2-46), C₁₄H₁₈O₂ (as shown in FIG. 2-47), C₁₃H₁₆O₄ (as shown in FIG. 2-48), C₁₁H₁₄O₂ (as shown in FIG. 2-49) or C₁₂H₁₆O₂ (as shown in FIG. 2-50).

FIG. 3 shows a flow chart of a manufacturing method of the phosphor stabilizer in accordance with a first preferred embodiment of the present invention. Referring to FIGS. 1-1 and 3, the manufacturing method of the phosphor stabilizer of the first preferred embodiment of the present invention includes the step S1: modifying the trimethoxysilylpropyl material with the polyethylenimine material in methylbenzene to obtain the trimethoxysilylpropyl-modified polyethylenimine material in a first solution and repeating the step if necessary. By way of example, a predetermined amount (e.g., 62 grams) of the polyethylenimine material is dissolved in the methylbenzene and is modified by the trimethoxysilylpropyl material, as shown in FIG. 1-1, to form the first solution which contains the trimethoxysilylpropyl-modified polyethylenimine material (CAS: 136856-91-2).

Referring again to FIG. 3, the manufacturing method of the phosphor stabilizer of the first preferred embodiment of the present invention includes the step S2: heating the trimethoxysilylpropyl-modified polyethylenimine material of the first solution in a predetermined temperature. By way of example, the predetermined temperature ranges between 80 and 120 degrees centigrade. In combination reaction, the heated first solution is supplied with a predetermined flow rate to a bottom or other suitable portion of a nitrogen filled reactor.

Referring again to FIGS. 2-1 and 3, the manufacturing method of the phosphor stabilizer of the first preferred embodiment of the present invention includes the step S3: dissolving the epoxy material in the methylbenzene to obtain a second solution. By way of example, a predetermined amount (e.g., 92 grams) of epoxy material C₁₃H₁₆O₄ (ethyl 2-[4-(oxiran-2-ylmethoxy)phenyl]acetate, CAS: 136856-91-2), as shown in FIG. 2-1, is dissolved in the methylbenzene to form the second solution which is supplied to a buffer device or the like.

Referring back to FIG. 3, the manufacturing method of the phosphor stabilizer of the first preferred embodiment of the present invention includes the step S4: reacting the heated first solution with the second solution in the nitrogen filled reactor by stirring to obtain a first reactant. By way of example, the heated first solution and the second solution are supplied with a predetermined molar ratio ranging between 1:2 to 1:4. The first reactant can be used as a dispersion carrier for reacting with the phosphors or the QD materials (e.g., 16 grams) to form a first phosphorescent synthetic which is further cooled and purified to obtain a colloid phosphor material. The first phosphorescent synthetic has a functional group to combine with the phosphor for enhancing a degree of luminous stability and thermal stability thereof. In a preferred embodiment, the manufacturing method of the phosphor stabilizer of the present invention can utilize other trimethoxysilylpropyl material and polyethylenimine material (e.g., C₆H₁₅O₃Si).

FIG. 3A shows a flow chart of a manufacturing method of the phosphor stabilizer in accordance with a second preferred embodiment of the present invention. Referring to FIGS. 1-1 and 3A, the manufacturing method of the phosphor stabilizer of the second preferred embodiment of the present invention includes the steps S1 and S2 identical with those of the first preferred embodiment, as shown in FIG. 3.

Turning now to FIGS. 2-2 and 3A, the manufacturing method of the phosphor stabilizer of a second preferred embodiment of the present invention includes the step S3A: by way of example, dissolving a predetermined amount (e.g., 32 grams) of epoxy material C₉H₁₀O₂, as shown in FIG. 2-2, in the methylbenzene to form a third solution which is supplied to a buffer device or the like.

Referring back to FIG. 3A, the manufacturing method of the phosphor stabilizer of the second preferred embodiment of the present invention includes the step S4A: reacting the heated first solution with the third solution in the nitrogen filled reactor by stirring to obtain a second reactant. By way of example, the heated first solution and the third solution are supplied with a predetermined molar ratio ranging between 1:2 to 1:4. The second reactant can be also used as a dispersion carrier for reacting with the phosphors or the QD materials (e.g., 16 grams) to form a second phosphorescent synthetic which is further cooled and purified to obtain a colloid phosphor material.

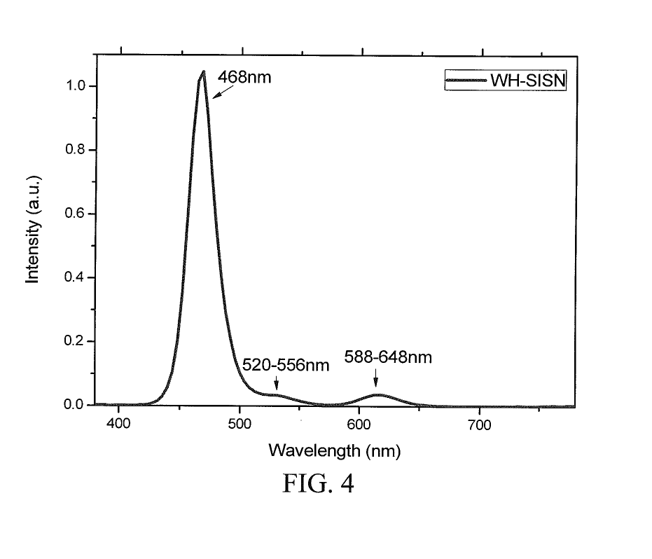

FIG. 4 shows a chart illustrating wavelengths in relation to luminous intensities of a phosphor in accordance with a preferred embodiment of the present invention, including three peaks. Referring to FIG. 4, by way of example, the second reactant is formed from trimethoxysilylpropyl material C₆H₁₅O₃Si reacting with polyethylenimine material C₉H₁₀O₂ and reacts with the phosphor to form a phosphorescent synthetic such as a blue-excited phosphor. The phosphorescent synthetic is a blue (468 nm) excited phosphor, as best shown in an arrow at left portion in FIG. 4, including a green (520 nm-580 nm) QD material, as best shown in an arrow at middle portion in FIG. 4, and a red (570 nm-660 nm) QD material, as best shown in an arrow at right portion in FIG. 4. Advantageously, the phosphorescent synthetic has a high degree of luminous stability and thermal stability and can be used as a surface stabilizer (agent) to coat or to displace a surface of the phosphor or the QD material.

Advantageously, the manufacturing method of the phosphor stabilizer of the present invention is obviously rapid, clean, high efficient, economic, easy-to-process, simplifies in purification, lowers byproduct, enhances luminous efficiency of the phosphorescent material, lowers the occurrence of shrinkage of products, and is suitable for mass production.

Although the invention has been described in detail with reference to its presently preferred embodiment, it will be understood by one of ordinary skills in the art that various modifications can be made without departing from the spirit and the scope of the invention, as set forth in the appended claims.

What is claimed is:

1. A phosphor stabilizer comprising:
a trimethoxysilylpropyl-modified polyethylenimine material provided with a first predetermined amount;
an epoxy material provided with a second predetermined amount; and
a reactant formed from the trimethoxysilylpropyl-modified polyethylenimine material reacted with the epoxy material in combination reaction;
wherein the reactant is a dispersion carrier performed as a stabilizer or a binder for reacting with a phosphor or a QD material to form a colloid phosphor material for enhancing a degree of luminous stability and thermal stability.

2. The phosphor stabilizer as defined in claim 1, wherein the trimethoxysilylpropyl-modified polyethylenimine material having a functional group for modifying and bonding polyethylenimine is a free radical of a trimethoxysilylpropyl material.

3. The phosphor stabilizer as defined in claim 2, wherein the trimethoxysilylpropyl material is C₆H₁₅O₃Si or C₆H₁₇O₃NSi.

4. The phosphor stabilizer as defined in claim 1, wherein the epoxy material is C₁₃H₁₆O₄, C₉H₁₀O₂, C₁₀H₁₂O₂, C₁₂H₁₆O₂, C₁₁H₁₄O₂, C₉H₁₀O, C₁₂H₁₆O₃, C₁₂H₁₄O₄, C₁₀H₁₂O₃, C₁₈H₂₈O₂, C₁₁H₁₄O₃, C₉H₁₀O, C₁₁H₁₂O₃, C₉H₉O₂F, C₁₀H₁₂O₂, C₁₅H₁₄O₂, C₉H₁₀O₂, C₁₄H₁₆O₃N₂, C₁₂H₁₄O₃, C₉H₉O₃N, C₁₈H₁₈O₃, C₁₅H₁₃O₂N, C₁₃H₁₂O₂, C₁₉H₃₈O₂, C₁₁H₂₂O₂, C₁₃H₂₆O₂, C₁₅H₃₀O₂, C₁₇H₃₄O₂, C₁₂H₈O₂F₁₆, C₈H₈O₂F₈, C₅H₆O₂F₄, C₁₁H₅OF₁₇, C₉H₅OF₁₃, C₁₁H₁₄O₄, C₁₁H₁₃O₃N, C₁₂H₁₄O₃, C₁₃H₁₈O₂, C₁₄H₂₀O₂, C₁₂H₁₄O₃, C₁₀H₉O₂F₃, C₁₀H₁₀O₄, C₁₂H₁₄O₂, C₁₄H₁₈O₂, C₁₃H₁₆O₄ or C₁₂H₁₆O₂.

5. The phosphor stabilizer as defined in claim 1, wherein the phosphor includes semiconductor nano-crystalline particles, metallic oxide particles and core-shell nano-crystals.

6. The phosphor stabilizer as defined in claim 1, wherein compounds of AgINS₂ and CuINS₂ in groups I-VI; compounds of CdSe, CdTe, ZnS, ZnSe, ZnTe, ZnO, HgS, HgSe, HgTe, CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, CdZnSeS, CdZnSeTe, CdZnSTe, CdHgSeS, CdHgSeTe, CdHgSTe, HgZnSeS, HgZnSeTe and HgZnSTe in groups II-VI; compounds of GaN, GaP, GaAs, GaSb, AlN, AlP, AlAs, AlSb, InN, InP, InAs, InSb, GaNP, GaNAs, GaNSb, GaPAs, GaPSb, AlNP, AlNAs, AlNSb, AlPAs, AlPSb, InNP, InNAs, InNSb, InPAs, InPSb, GaAlNP, GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs and InAlPSb in groups III-V; compounds of SnS, SnSe, SnTe, PbS, PbSe, PbTe, SnSeS, SnSeTe, SnSTe, PbSeS, PbSeTe, PbSTe, SnPbS, SnPbSe, SnPbTe, SnPbSSe, SnPbSeTe and SnPbSTe in groups IV-VI; compounds of Si, Ge, SiC and SiGe in group IV.

7. A phosphorescent material comprising:
a phosphor or a QD material provided with a first predetermined amount;
a dispersion carrier provided with a second predetermined amount; and
a colloid phosphor material formed from the a first predetermined amount of the phosphor or the QD material reacted with the second predetermined amount of the dispersion carrier in a first combination reaction;
wherein in a second combination reaction the dispersion carrier is formed from a trimethoxysilylpropyl-modified polyethylenimine material reacted with an epoxy material in combination reaction.

8. The phosphorescent material as defined in claim 7, wherein the trimethoxysilylpropyl-modified polyethylenimine material having a functional group for modifying and bonding polyethylenimine is a free radical of a trimethoxysilylpropyl material.

9. The phosphorescent material as defined in claim 8, wherein the trimethoxysilylpropyl material is C₆H₁₅O₃Si or C₆H₁₇O₃NSi.

10. The phosphorescent material as defined in claim 7, wherein the epoxy material is C₁₃H₁₆O₄, C₉H₁₀O₂, C₁₀H₁₂O₂, C₁₂H₁₆O₂, C₁₁H₁₄O₂, C₉H₁₀O, C₁₂H₁₆O₃, C₁₂H₁₄O₄, C ₁₀H₁₂O₃, C₁₈H₂₈O₂, C₁₁H₁₄O₃, C₉H₁₀O, C₁₁H₁₂O₃, C₉H₉O₂F, C₁₀H₁₂O₂, C₁₅H₁₄O₂, C₉H₁₀O₂, C₁₄H₁₆O₃N₂, C₁₂H₁₄O₃, C₉H₉O₃N, C₁₈H₁₈O₃, C₁₅H₁₃O₂N, C₁₃H₁₂O₂, C₁₉H₃₈O₂, C₁₁H₂₂O₂, C₁₃H₂₆O₂, C₁₅H₃₀O₂, C₁₇H₃₄O₂, C₁₂H₈O₂F₁₆, C₈H₈O₂F₈, C₅H₆O₂F₄, C₁₁H₅OF₁₇, C₉H₅OF₁₃, C₁₁H₁₄O₄, C₁₁H₁₃O₃N, C₁₂H₁₄O₃, C₁₃H₁₈O₂, C₁₄H₂₀O₂, C₁₂H₁₄O₃, C₁₀H₉O₂F₃, C₁₀H₁₀O₄, C₁₂H₁₄O₂, C₁₄H₁₈O₂, C₁₃H₁₆O₄ or C₁₂H₁₆O₂.

11. The phosphorescent material as defined in claim 7, wherein the phosphor includes semiconductor nano-crystalline particles, metallic oxide particles and core-shell nano-crystals.

12. The phosphorescent material as defined in claim 7, whereincompounds of AgINS₂ and CuINS₂ in groups I-VI; compounds of CdSe, CdTe, ZnS, ZnSe, ZnTe, ZnO, HgS, HgSe, HgTe, CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, CdZnSeS, CdZnSeTe, CdZnSTe, CdHgSeS, CdHgSeTe, CdHgSTe, HgZnSeS, HgZnSeTe and HgZnSTe in groups II-VI; compounds of GaN, GaP, GaAs, GaSb, AlN, AlP, AlAs, AlSb, InN, InP, InAs, InSb, GaNP, GaNAs, GaNSb, GaPAs, GaPSb, AlNP, AlNAs, AlNSb, AlPAs, AlPSb, InNP, InNAs, InNSb, InPAs, InPSb, GaAlNP, GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs and InAlPSb in groups III-V; compounds of SnS, SnSe, SnTe, PbS, PbSe, PbTe, SnSeS, SnSeTe, SnSTe, PbSeS, PbSeTe, PbSTe, SnPbS, SnPbSe, SnPbTe, SnPbSSe, SnPbSeTe and SnPbSTe in groups IV-VI; compounds of Si, Ge, SiC and SiGe in group IV.

13. A manufacturing method of phosphorescent materials comprising:
modifying a trimethoxysilylpropyl material with a polyethylenimine material in methylbenzene to obtain a trimethoxysilylpropyl-modified polyethylenimine material in a first solution;
heating the trimethoxysilylpropyl-modified polyethylenimine material of the first solution in a predetermined temperature;
dissolving an epoxy material in methylbenzene to obtain a second solution; and
reacting the heated first solution with the second solution in a reactor by stirring to obtain a reactant;
wherein the reactant is a dispersion carrier for reacting with a phosphor or a quantum dot material to form a phosphorescent synthetic.

14. The manufacturing method as defined in claim 13, wherein the predetermined temperature ranges between 80 and 120 degrees centigrade.

15. The manufacturing method as defined in claim 13, wherein the heated first solution and the second solution are supplied with a predetermined molar ratio ranging between 1:2 to 1:4.

16. The manufacturing method as defined in claim 13, wherein the phosphorescent synthetic is further cooled and purified to obtain a colloid phosphor material.
